(19) United States
(12) Patent Application Publication
(10) Pub. No.: US 2024/0372473 A1
(43) Pub. Date: Nov. 7, 2024

(54) METHODS AND SYSTEMS OF A MULTI-PHASE SWITCHING POWER CONVERTER

(71) Applicant: SEMICONDUCTOR COMPONENTS INDUSTRIES, LLC, Scottsdale, AZ (US)

(72) Inventor: Alessandro ZAFARANA, Milano (IT)

(73) Assignee: SEMICONDUCTOR COMPONENTS INDUSTRIES, LLC, Scottsdale, AZ (US)

(21) Appl. No.: 18/313,105

(22) Filed: May 5, 2023

(51) Int. Cl. H02M 3/158; H02M 1/08

(52) U.S. Cl. CPC H02M 3/1586; H02M 1/08

(57) ABSTRACT

Multi-phase switching power converter. At least one example is a method of operating a multi-phase power converter, the method comprising: operating, by a voltage regulator, a first phase of the multi-phase power converter at a frequency and a first phase-relationship, the first phase comprising first and second power modules; operating, by the voltage regulator, a second phase of the multi-phase power converter at the frequency and a second phase-relationship different than the first phase-relationship, the second phase comprising third and fourth power modules; at least partially balancing current, by the voltage regulator, as between the first phase and the second phase by controlling a first or second duty cycles, respectively; and at least partially balancing current as between the first and second power modules of the first phase based on a local-sharing signal coupled between the first and second power modules.

### CROSS-REFERENCE TO RELATED APPLICATIONS

Not Applicable.

### BACKGROUND

In the high performance computer market, such as computer systems implementing artificial intelligence, the supply voltage to the processors is decreasing and supply current is increasing. The lower voltage and higher current operation of the processors may strain the DC-DC switching power converters that regulate the voltage. For example, a DC-DC switching power converter may be provided an unregulated input voltage between 10 Volts (V) and 15V, and the DC-DC switching power converter may produce a regulated output voltage of about 0.6V. Moreover, the DC-DC switching power converter may need to supply 1000 Amps (A) or more, with a rate of change of current on the order 1000 A per microsecond.

### SUMMARY

At least one example is a method of operating a multi-phase power converter, the method comprising: operating, by a voltage regulator, a first phase of the multi-phase power converter at a frequency and a first phase-relationship, the first phase comprising first and second power modules; operating, by the voltage regulator, a second phase of the multi-phase power converter at the frequency and a second phase-relationship different than the first phase-relationship, the second phase comprising third and fourth power modules; at least partially balancing current, by the voltage regulator, as between the first phase and the second phase by controlling a first or second duty cycles, respectively; and at least partially balancing current as between the first and second power modules of the first phase based on a local-sharing signal coupled between the first and second power modules.

In the example method, at least partially balancing current as between the first and second power modules may further comprise, extending a charge mode of the first power module to be longer than a charge mode of the second power module, the extending based on the local-sharing signal indicating the first power module is carrying less current or is cooler than the second power module.

In the example method, at least partially balancing current as between the first and second power modules may further comprise, extending a charge mode of the first power module to be longer than a charge mode of the second power module, the extending based on the local-sharing signal indicating the first power module is cooler than the second power module.

In the example method, at least partially balancing current as between the first and second power modules may further comprise, extending a charge mode of the first power module to be longer than a charge mode of the second power module, the extending based on the local-sharing signal indicating the first power module is carrying less current cooler than the second power module.

In the example method, at least partially balancing current as between the first and second power modules may further comprise: coupling, by the first power module, an input voltage to a first switch node responsive to assertion of a first drive signal from the voltage regulator, the coupling defines a first charge mode; coupling, by the second power module, the input voltage to a second switch node responsive to assertion of the first drive signal; responsive to de-assertion of the first drive signal, de-coupling the second switch node from the input voltage and coupling the second switch node to ground by the second power module; responsive to de-assertion of the first drive signal, extending the first charge mode by the first power module, the extending based on the local-sharing signal indicating the first power module is carrying less current or is cooler than the second power module; and then de-coupling the first switch node from the input voltage and coupling the first switch node to ground by the first power module.

Yet another example is a power module, comprising: a drive-in terminal, a current-monitor terminal, a temperature-monitor terminal, a local-sharing terminal, and a switch-node terminal; a high-side FET defining a drain, a source coupled to the switch-node terminal, and a gate; a low-side FET defining a drain coupled to the switch-node terminal, a source, and a gate; a means for measuring temperature thermally coupled to the high-side FET and the low-side FET, the means for measuring temperature defines a temperature output; and a controller coupled to the gate of the high-side FET, the gate of the low-side FET, the drive-in terminal, the current-monitor terminal, the temperature-monitor terminal, the local-sharing terminal, and the temperature output. The controller may be configured to: responsive to assertion of the drive-in terminal, make the low-side FET non-conductive and the high-side FET conductive to define a charge mode; drive a signal indicative of current to the current-monitor terminal; drive a signal indicative of temperature to the temperature-monitor terminal; responsive to de-assertion of the drive-in terminal, extend the charge mode based on a signal at the local-sharing terminal; and then make the high-side FET non-conductive and the low-side FET conductive to define a discharge mode.

In the example power module, when the controller extends the charge mode, the controller may be configured to extend the charge mode if the signal on the local-sharing terminal indicates the power module carries less current than a parallel power module coupled to the local-sharing terminal.

In the example power module, when the controller extends the charge mode, the controller may be configured to extend the charge mode if the signal on the local-sharing terminal indicates the power module has a lower temperature than a parallel power module coupled to the local-sharing terminal.

In the example power module, when the controller extends the charge mode, the controller may be configured to extend the charge mode if the signal on the local-sharing terminal indicates the power module both: carries less current than a parallel power module coupled to the local-sharing terminal; and has a lower temperature than the parallel power module coupled to the local-sharing terminal.

In the example power module, controller may be further configured to refrain from extending a second charge mode if the signal on the local-sharing terminal indicates the power module carries the same or more current than a parallel power module coupled to the local-sharing terminal.

In the example power module, the controller may be further configured to refrain from extending a second charge mode if the signal on the local-sharing terminal indicates the power module has a same or a higher temperature than a parallel power module coupled to the local-sharing terminal.

In the example power module, the controller may be further configured to refrain from extending a second charge mode if the signal on the local-sharing terminal indicates the power module either: carries the same or more current than a parallel power module coupled to the local-sharing terminal; or has the same or higher temperature than the parallel power module coupled to the local-sharing terminal.

Yet another example may be a multi-phase power converter, comprising: a voltage regulator defining first and second phase-drive terminals, first and second IMON-input terminals, first and second TMON-input terminals, and a voltage-feedback terminal, the voltage regulator configured to drive a first-phase drive signal to the first phase-drive terminal at a first phase and to drive a second-phase drive signal to the second phase-drive terminal at a second phase different than the first phase; a first phase defining a first drive input coupled to the first phase-drive terminal, a first current-monitor output coupled to the first IMON-input terminal, and a first temperature monitor output coupled to the first TMON-input terminal; and a second phase. The second phase may comprise: a first power module defining a first drive-in terminal, a first current-monitor terminal, a first temperature-monitor terminal, a first local-sharing terminal, and a first switch-node terminal coupled to a first inductor; a second power module defining a second drive-in terminal, a second current-monitor terminal, a second temperature-monitor terminal, a second local-sharing terminal, and a second switch-node terminal coupled to a second inductor; the first and second drive-in terminals coupled together and defining a second drive input coupled to the second phase-drive terminal; the first and second current-monitor terminals coupled together and defining a second current-monitor output coupled to the second TMON-input terminal; the first and second temperature-monitor terminals coupled together and defining a second temperature monitor output coupled to the second TMON-input terminal; and the first and second local-sharing terminals coupled together. The voltage regulator may be configured to at least partially balance current as between the first and second phases based on the first and second IMON-input terminals and/or the first and second TMON-input terminals; and the first and second power modules may be configured to at least partially balance current as between the first and second power modules based on the first and second local-sharing terminals.

In the example multi-phase power converter, the first power module may be configured to: couple an input voltage to the first switch-node terminal responsive to assertion of the first drive-in terminal to define a first charge mode; drive a signal indicative of current to the first current-monitor terminal; drive a signal indicative of temperature to the first temperature-monitor terminal; responsive to de-assertion of the first drive-in terminal, extend the first charge mode based on a signal at the first local-sharing terminal; and then couple a ground reference to the first switch-node terminal to define a first discharge mode. Further in the example multi-phase power converter, the second power module may be configured to: couple the input voltage to the second switch-node terminal responsive to assertion of the first drive-in terminal; drive a signal indicative of current to the second current-monitor terminal; drive a signal indicative of temperature to the second temperature-monitor terminal; and responsive to de-assertion of the first drive-in terminal during the first discharge mode, couple a ground reference to the second switch-node terminal. When the first power module extends the first charge mode, the first power module may be configured to extend the first charge mode if the signal on the first local-sharing terminal indicates the first power module carries less current than the second power module. When the first power module extends the first charge mode, the first power module may be configured to extend the first charge mode if the signal on the first local-sharing terminal indicates the first power module has a lower temperature than the second power module. When the first power module extends the first charge mode, the first power module may be configured to extend the first charge mode if the signal on the first local-sharing terminal indicates the first power module both: carries less current than the second power module; and has a lower temperature than the second power module. The second power module may be further configured to extend a second charge mode if the signal on the second local-sharing terminal indicates the second power module carries less current than the first power module. The second power module may be further configured to extend a second charge mode if the signal on the second local-sharing terminal indicates the second power module has a lower temperature than the first power module. The second power module may be further configured to extend a second charge mode if the signal on the second local-sharing terminal indicates the second power module both: carries less current than the first power module; and has a lower temperature than the first power module.

### BRIEF DESCRIPTION OF THE DRAWINGS

For a detailed description of example embodiments, reference will now be made to the accompanying drawings in which:

FIG. 1 shows a multi-phase power converter in accordance with at least some embodiments;

FIG. 2 shows, in block diagram form, an example phase of the multiphase power converter of FIG. 1 in accordance with at least some embodiments;

FIG. 3 shows a timing diagram in accordance with at least some embodiments;

FIG. 4 shows a partial electrical schematic, partial block diagram, of a power module in accordance with at least some embodiments;

FIG. 5 shows a partial electrical schematic, partial block diagram, of a controller in accordance with at least some embodiments;

FIG. 6 shows a method in accordance with at least some embodiments

### DEFINITIONS

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or a direct connection. Thus, if a first device couples to a second device, that connection may be through a direct connection or through an indirect connection via other devices and connections.

“About” in reference to a recited parameter shall mean the recited parameter plus or minus ten percent (+/−10%) of the recited parameter.

“FET” shall mean a field effect transistor, such as a junction-gate FET (JFET) or metal-oxide-semiconductor FET (MOSFET).

The terms “input” and “output” when used as nouns refer to connections (e.g., electrical, software), and shall not be read as verbs requiring action. For example, a timer circuit may define a clock output. The example timer circuit may create or drive a clock signal on the clock output. In systems implemented directly in hardware (e.g., on a semiconductor substrate), these “inputs” and “outputs” define electrical connections. In systems implemented in software, these “inputs” and “outputs” define parameters read by or written by, respectively, the instructions implementing the function.

“Assert” shall mean creating or maintaining a first predetermined state of a Boolean signal. Boolean signals may be asserted high or with a higher voltage, and Boolean signals may be asserted low or with a lower voltage, at the discretion of the circuit designer. Similarly, “de-assert” shall mean creating or maintaining a second predetermined state of the Boolean, opposite the asserted state.

“Controller” shall mean, alone or in combination, individual circuit components, an application specific integrated circuit (ASIC), a microcontroller with controlling software, a reduced-instruction-set computing (RISC) with controlling software, a digital signal processor (DSP), a processor with controlling software, a programmable logic device (PLD), a field programmable gate array (FPGA), or a programmable system-on-a-chip (PSOC), configured to read inputs and drive outputs responsive to the inputs.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various examples are directed to methods and systems of multi-phase switching power converters. More particularly, various examples are directed to multi-phase switching power converters in which a voltage regulator controls current as between the phases to at least partially balance current between the phases and/or to at least partially balance temperature as between the phases. Moreover, in various examples each phase may comprise a plurality of power modules, and within a phase the power modules at least partially balance current and/or temperature as between the power modules based a local current-sharing signal. In this way, a voltage regulator designed to control N phases may control 2N power modules without changing the design or operation of voltage regulator. The specification turns to an example multi-phase power converter to orient the reader.

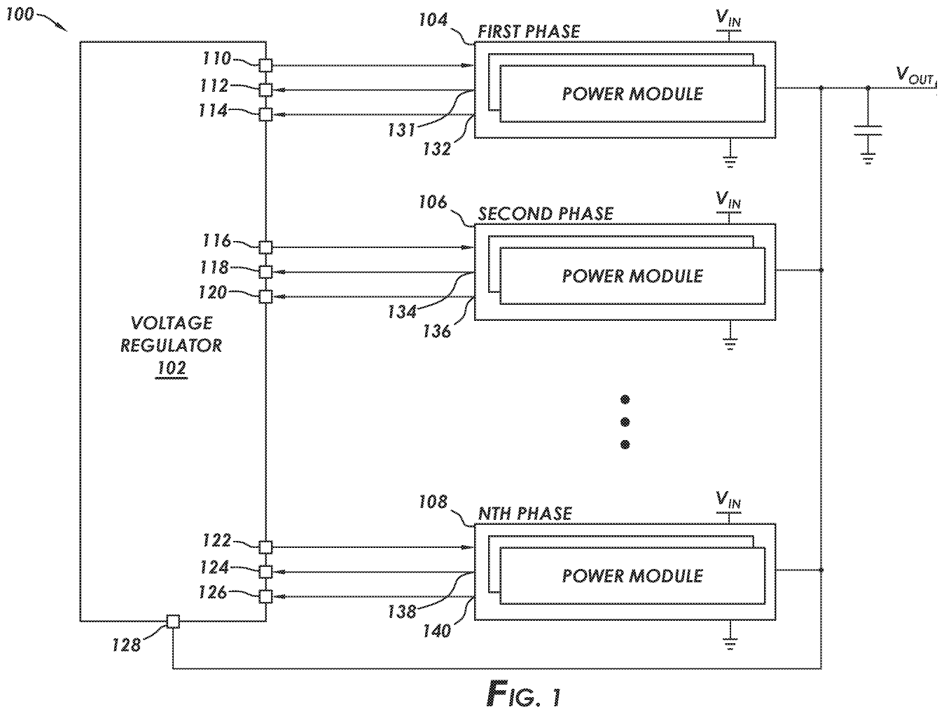

FIG. 1 shows an example multi-phase power converter 100. In particular, the example multi-phase power converter 100 comprises a voltage regulator 102 and a plurality of phases (e.g., power stages), such as first phase 104 (e.g., a first power stage), a second phase 106 (e.g., a second power stage), and an Nth phase 108 (e.g., an Nth power stage). In some cases, the voltage regulator 102 is designed and constructed to control two or more phases, such as 12 phases or 16 phases. The phases are provided with drive signals at the same frequency, but with varying phase-relationship. For example, for a two phase system the drive signals may be separated by 180 degrees of phase-relationship. As another example, for a sixteen phase system the drive signals may be separated by 22.5 degrees of phase-relationship.

For each phase of the multi-phase power converter 100, the example voltage regulator 102 may define a phase-drive terminal, current monitor or I_{MON}-input terminal, and a temperature monitor or T_{MON}-input terminal. For example, for the first phase 104 the example voltage regulator 102 defines a phase-drive terminal 110, an I_{MON}-input terminal 112 coupled to a current-monitor output 130, and a T_{MON}-input terminal 114 coupled to temperature monitor output 132. Similarly, for the second phase 106 the example voltage regulator 102 defines a phase-drive terminal 116, an I_{MON}-input terminal 118 coupled to a current-monitor output 134, and a T_{MON}-input terminal 120 coupled to a temperature-monitor output 136. Similarly, for the Nth phase 108 the example voltage regulator 102 defines a phase-drive terminal 122, an I_{MON}-input terminal 124 coupled to current monitor output 138, and a T_{MON}-input terminal 126 coupled to a temperature monitor output 140. For each phase, additional terminals may be present, such as enable terminal, but the additional terminals are not shown so as not to further complicate the figure.

Still referring to FIG. 1, the example voltage regulator 102 further defines a feedback terminal 128. The example feedback terminal 128 is coupled to the voltage output V_{OUT}. In some cases, the voltage output V_{OUT} is about 0.6V, and thus the feedback terminal 128 may be directly coupled to the voltage output V_{OUT}. However, in other cases the feedback terminal 128 may couple to the voltage output V_{OUT} by way of a voltage divider. Based on the feedback signal received through the feedback terminal 128, the voltage regulator 102 controls the various phases to control the voltage output V_{OUT} and/or the current provided. For example, for systems with fixed operating frequency, the voltage regulator 102 may adjust the duty cycle of the drive signals applied to each phase through respective phase-drive terminals 110, 116, and 122 to control the voltage output V_{OUT}. In yet other cases, the voltage regulator 102 may adjust the overall frequency of the drive signals applied to each phase through respective phase-drive terminals 110, 116, and 122 to control the voltage output V_{OUT}. In low load situations, the voltage regulator may disable certain of the phases, and change the phase-relationship of the drive signals applied to the remaining phases.

In accordance with various example systems, the voltage regulator 102 is designed and constructed to at least partially balance current carried by the respective phases. That is, variations in the construction, placement, and/or temperature of the phases may cause imbalances in current carried by each phase in spite of being provided identical drive signals driven to the respective phase-drive terminals 110, 116, and 122. To accomplish the at least partial balancing of current, in example systems the voltage regulator 102 receives an indication of current carried by each phase by way of the respective I_{MON}-input terminals 112, 118, and 124.

In particular, each phase provides a signal indicative of current carried by the phase to the respective I_{MON}-input terminals 112, 118, and 124. In some examples, each signal indicative of current carried by the phase is itself a current having magnitude directly proportional to load current provided by the phase. In one example, the signal indicative of current carried by each phase may have a magnitude of 5 micro-Amps (μA) for each amp of load current provided by the phase (i.e., 5 μA/A). Based on the signals indicative of current provided by the respective phases, the voltage regulator 102 makes changes in the pulse width or duty cycle of the drive signals provided to each phase. If a phase is providing more current than one or more other phases, the voltage regulator 102 may decrease the duty cycle of the drive signal provided to that phase relative to the other phases. Additionally or alternatively, if a phase is providing less current than one or more other phases, the voltage regulator 102 may increase the duty cycle of the drive signal provided to that phase relative to the other phases.

Further, in accordance with various examples, the voltage regulator 102 is designed and constructed to at least partially balance temperature as between the respective phases. That is, variations in the construction and placement of the phases may cause imbalances in temperature of each phase in spite of each phase providing identical load current. For example, a phase that abuts a heat sink in the form of a cold wall in proximity to a fluid circulating tube may be cooler than another phase also abutting the cold wall, but spaced apart from the location of the fluid circulating tube. Thus, in some examples the voltage regulator 102 receives an indication of temperature of each phase by way of the respective T_{MON}-input terminals 114, 120, and 126.

In particular, each phase generates a signal indicative of temperature of the phase, and drives the signal indicative of temperature to the respective T_{MON}-input terminals 114, 120, and 126. In some examples, each signal indicative of temperature is a voltage having a magnitude directly proportional to temperature of the phase. In one example, the signal indicative of temperature may have a magnitude of 8 milli-Volts (mV) per degree Celsius of the phase (i.e., 8 mV/° C.). Based on the signals indicative of temperature of the respective phases, the voltage regulator 102 makes changes in pulse width or duty cycle of the drive signals provided to each phase. If a phase is hotter than one or more other phases, the voltage regulator 102 may decrease the duty cycle of the drive signal provided to that phase relative to the other phases. Additionally or alternatively, if a phase is cooler than one or more other phases, the voltage regulator 102 may increase the duty cycle of the drive signal provided to that phase relative to the other phases.

Current and temperature are closely related, with changes in temperature lagging changes in current. That is, to at least partially balance temperature of a phase, the voltage regulator 102 adjusts load current carried by the phase. Thus, the voltage regulator 102 may primarily attempt to balance current among the phases, but then modify load current on a per-phase basis in an attempt to balance temperature.

Still referring to FIG. 1, in order to meet high current and high current transients (e.g., 1000 A/μs), at least some of phases of the multi-phase power converter 100 may comprise a plurality of power modules. For example, the first phase 104 may comprise two or more power modules. Likewise, the second phase 106 through the Nth phase 108 may each comprise two or more power modules. For phases with a plurality of power modules, the power modules within the phase are operated at the same frequency and phase-relationship. For example, the drive signal driven from the phase-drive terminal 110 by the voltage regulator 102 is provided to the power modules of the first phase 104. It follows, the power modules of the first phase 104 both operate at the same phase-relationship. The drive signal driven from the phase-drive terminal 116 is provided to the power modules of the second phase 106, and thus the power modules of the second phase 106 both operate at the same phase-relationship different than the phase-relationship of the first phase 104. The drive signal driven from the phase-drive terminal 122 is provided to the power modules of the Nth phase 108, and thus the power modules of the Nth phase 108 both operate at the same phase-relationship different than the phase-relationship of the first phase 104 and the second phase 106.

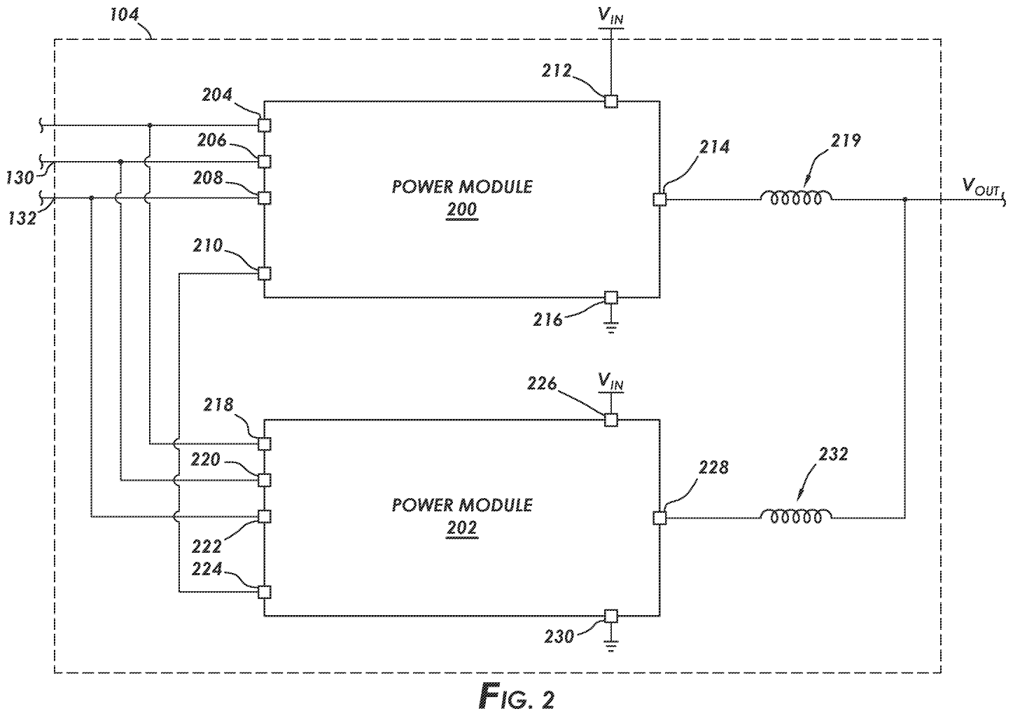

FIG. 2 shows, in block diagram form, an example phase of the multiphase power converter 100. In particular, FIG. 2 shows the first phase 104 with the understanding the first phase 104 is illustrative of any phase having multiple power modules. The example first phase 104 comprises a power module 200 and a separate and distinct power module 202. In some examples, the power modules 200 and 202 are identical in design and construction, but may have slight variances based on manufacturing tolerances and manufacturing variability. Referring initially to the power module 200, the example power module 200 comprises a drive-in terminal 204, a current-monitor terminal 206, a temperature-monitor terminal 208, a local-sharing terminal 210, an input-voltage terminal 212, a switch-node terminal 214, and a reference terminal 216. Additional terminals will be present, such as a V_{CC} terminal to power the internal circuits, a V_{CC}-return terminal, and an enable terminal, but the additional terminals are not shown so as not to unduly complicate the figure.

In various examples, the drive-in terminal 204 is coupled to the phase-drive terminal 110 (FIG. 1), the current-monitor terminal 206 is coupled to the I_{MON}-input terminal 112 (FIG. 1), and the temperature-monitor terminal 208 is coupled to the T_{MON}-input terminal 114 (FIG. 1). On the other side of the power module 200, the input-voltage terminal 212 is coupled to the voltage input V_{IN}, and the reference terminal 216 is coupled to a reference voltage, such as common or ground. The switch-node terminal 214 is coupled to a first lead of an inductor 219, and the second lead of the inductor 219 is coupled to the voltage output V_{OUT}.

In operation, the example power module 200 receives a drive signal on the drive-in terminal 204. When the drive signal is asserted, the power module 200 is designed and constructed to decouple the switch-node terminal 214 from the ground reference, and then couple the voltage input V_{IN} to the switch-node terminal 214. When the voltage input V_{IN} is coupled to the switch-node terminal 214 and thus the inductor 219, the current through the inductor 219 increases, storing energy in the field around the inductor 219. Thus, periods of time when the voltage input V_{IN} is coupled to the inductor 219 are referred to as charge modes. When the drive signal received on the drive-in terminal 204 is de-asserted, the power module 200 is designed and constructed to de-couple the voltage input V_{IN} from the switch-node terminal 214, and then couple the reference voltage to the switch-node terminal 214. Because the current through an inductor cannot change instantaneously, the current through the inductor 219 continues the flow to the voltage output V_{OUT} as the field around the inductor 219 collapses. Periods of time when the field around the inductor 219 is collapsing are referred to as discharge modes. Thus, the example power module 200 and inductor 219 operate as a DC-DC switching power converter, and in particular a buck-type DC-DC switching power converter.

The example power module 200 is designed and constructed to drive the signal indicative of current to the current-monitor terminal 206 during the charge modes, or during the discharges, or both. Likewise, the example power module 200 is designed and constructed to drive the signal indicative of temperature to the temperature-monitor terminal 208 during the charge modes, or during the discharges, or both.

Still referring to FIG. 2, the example first phase 104 further comprises the power module 202. The power module 202 comprises a drive-in terminal 218, a current-monitor terminal 220, a temperature-monitor terminal 222, a local-sharing terminal 224, an input-voltage terminal 226, a switch-node terminal 228, and a reference terminal 230. Additional terminal will be present, such as a V_{CC} terminal to power the internal circuits, a V_{CC}-return terminal, and an enable terminal, but the additional terminals are not shown so as not to unduly complicate the figure.

In various examples, the drive-in terminal 218 is coupled to the phase-drive terminal 110 (FIG. 1) and thus the drive-in terminal 204 of the power module 200. The current-monitor terminal 220 is coupled to the I_{MON}-input terminal 112 (FIG. 1) and thus the current-monitor terminal 206 of the power module 200. The temperature-monitor terminal 222 is coupled to the T_{MON}-input terminal 114 (FIG. 1) and thus the temperature-monitor terminal 208 of the power module 200. On the other side of the power module 202, the input-voltage terminal 226 is coupled to the voltage input V_{IN}, and the reference terminal 230 is coupled to a reference voltage, such as common or ground. The switch-node terminal 228 is coupled to a first lead of an inductor 232, the second lead of the inductor 232 is coupled to the voltage output V_{OUT}.

In operation, the example power module 202 receives a drive signal on the drive-in terminal 218. When the drive signal is asserted, the power module 202 is designed and constructed to decouple the switch-node terminal 228 from the ground reference, and then couple the voltage input V_{IN} to the switch-node terminal 228, thus defining a charge mode. When the drive signal received on the drive-in terminal 218 is de-asserted, the power module 202 is designed and constructed to de-couple the voltage input V_{IN} from the switch-node terminal 228, and then couple the reference voltage to the switch-node terminal 228, thus defining a discharge mode.

The example power module 202 likewise drives a signal indicative of current to the current-monitor terminal 220 during the charge modes, or during the discharges, or both. Likewise, the example power module 202 is designed and constructed to drive the signal indicative of temperature to the temperature-monitor terminal 222 during the charge modes, or during the discharges, or both.

Considering the signals indicative of current created by the power modules 200 and 202. As mentioned above, in some examples each power module drives a current whose magnitude is proportional to the load current provided by the power module (e.g., 5 μA/A). Coupling directly together the current-monitor terminal 206 of the power module 200 and the current-monitor terminal 220 of the power module 202 effectively sums the signals indicative of current at the voltage regulator 102 (FIG. 1). Stated differently, the voltage regulator 102 receives the sum of the currents, and thus receives an indication of the total load current provided by the example first phase 104. However, the example signals indicative of temperature are each a voltage proportional temperature (e.g., 8 mV/° C.). Coupling directly together the temperature-monitor terminal 208 of the power module 200 and the temperature-monitoring terminal 222 of the power module 202 is effectively a logic OR function, with the highest voltage “winning” or dominating. Stated differently, the voltage regulator 102 receives a voltage indicative of the highest temperature as between the power modules 200 and 202.

While having multiple power modules 200 and 202 within the example first phase 104 enables the voltage regulator 102 to control more power modules, the voltage regulator 102 loses visibility into the current balance and temperature balance as between the power modules 200 and 202. That is, the voltage regulator 102 cannot discern when there is an imbalance of temperature, current, or both as between the example power modules 200 and 202.

The issues noted are addressed, at least in part, by the use of a local-sharing signal exchanged between the power modules of a phase, such as the example power modules 200 and 202. More particularly, in various examples the local-sharing terminal 210 of the power module 200 is directly coupled to the local-sharing terminal 224 of the power module 202. Based on signals driven to the respective local-sharing terminals by the power modules 200 and 202, the power modules themselves at least partially balance current as between them. The control of current as between the power modules 200 and 202 may directly implement current balancing, temperature balancing (by enforcing slight differences in current), or a blend of current and temperature balancing.

One of the issues with having the example power modules 200 and 202 exchange signals is that each power module conforms to an industry-standard pinout dictated by a major player in the processor market. Thus, in conforming to the industry standard, only one terminal (e.g., the LCS terminal) is available to each individual power module manufacturer to implement manufacturer-specific features. Some related art power modules utilize the LCS terminal as the mechanism for the power module to be informed of the magnitude of the inductance of an attached inductor (e.g., using an external resistor), thus leaving no additional terminals. In accordance with various embodiments, the LCS terminal is used to exchange the local-sharing signals, and thus the LCS terminal is referred to herein as the local-sharing terminal (e.g., local-sharing terminal 210, local-sharing terminal 224).

In particular, in some examples each of the example power modules 200 and 202 drives a signal to their respective local-sharing terminals 210 and 224, where each signal is indicative of the load current provided by the power module, the temperature of the power module, or a combination of the load current and temperature. Any characteristic or feature of the signal driven may indicate the parameter(s) to be shared, such as voltage, current, frequency, duty cycle, or the like. Moreover, in some cases the power modules 200 and 202 may be designed and constructed for serial communication using the local-sharing terminals 210 and 224. The various embodiments were developed in the context of each power module 200 and 202 driving a voltage indicative the parameter(s) to be shared, and thus the description is based on the developmental context; however, any characteristic or feature may be used.

Thus, in various examples, the local-sharing terminals 210 and 224 coupled directly together, and such coupling is effectively a logic OR function, with the highest voltage “winning” or dominating. For example, if the power module 200 carries more current, is hotter, or perhaps both, a voltage signal driven by the power module 200 to the local-sharing terminal 210 will override or dominate a voltage signal driven by the power module 202 to its local-sharing terminal 224. Oppositely, if the power module 202 carries more current, is hotter, or perhaps both, the voltage signal driven by the power module 202 to the local-sharing terminal 224 will override or dominate the voltage signal driven by the power module 200 to its local-sharing terminal 210.

Assume, for purpose of explanation, that the power module 200 is providing more load current and/or is hotter, and thus the voltage signal driven to the local-sharing terminal 210 by the power module 200 overrides or dominates the voltage signal the power module 202 attempts to drive. The example power module 202 is designed and constructed to sense that the power module 200 is providing more load current and/or is hotter by an analysis of the signal at its local-sharing terminal 224. The power module 202 is further designed and constructed to extend one or more charge modes such that the power module 202 carries more load current than previous switching cycles, thus at least partially balancing the load current and/or temperature.

Now assume the opposite situation, that the power module 202 is providing more load current and/or is hotter, and thus the voltage signal driven to the local-sharing terminal 224 by the power module 202 overrides or dominates the voltage signal of the power module 200. The example power module 200 is likewise designed and constructed to sense that the power module 202 is providing more load current and/or is hotter by an analysis of the voltage at its local-sharing terminal 210. The power module 200 is further designed and constructed to extend one or more charge modes such that the power module 200 carries more load current than in previous switching cycles, thus at least partially balancing the load current and/or temperature. Stated slightly differently, if a power module determines the power module is carrying less load current and/or is cooler, the power module may selectively extend one or more charge mode, and if the power module determines the power module is carrying more load current and/or is hotter, the power module refrains from extending charge modes.

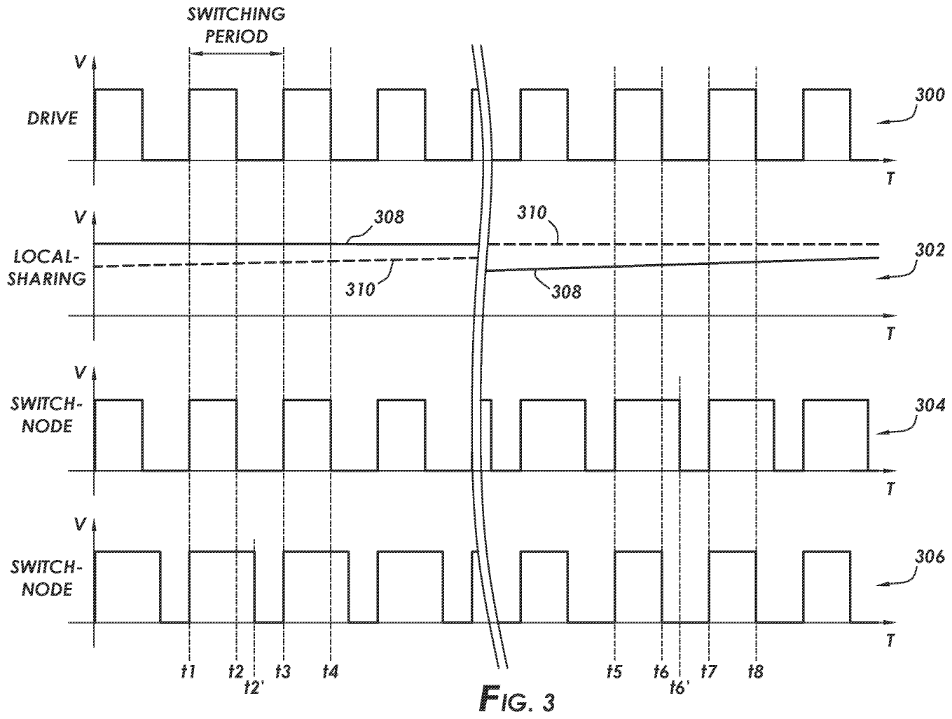

FIG. 3 shows a timing diagram in accordance with at least some embodiments. In particular, FIG. 3 shows: an example drive signal 300; an example local-sharing signal 302; an example switch-node voltage 304 for the example power module 200; and an example switch-node voltage 306 for the example power module 202. While the signals are separately plotted, the signal are shown along corresponding time axes. The signals are not necessarily to scale in either magnitude or duration. The example drive signal 300, as provided from the voltage regulator 102, is periodically asserted, here asserted high or with high voltage, such as between times t1 to t2 and times t3 to t4. The duration between any two corresponding transitions of the drive signal is considered a switching period. For example, the duration between time t1 and time t3 is a switching period. The frequency of operation is the inverse of the duration (i.e., f=1/(switching period)).

The local-sharing signal 302 is plotted just below the example drive signal 300. In one example, each of the power modules may attempt to drive a voltage signal to their respective local-sharing terminals. Coupling the local-sharing terminals directly together is effectively a logic OR function, with the highest voltage “winning” or dominating. In particular, co-plotted are a local-sharing signal 308 driven by the example power module 200 and a local-sharing signal 310 driven by the example power module 202. In the left half of FIG. 3, the local-sharing signal 308 is higher and thus overrides or dominates, meaning the example power module 200 provides higher load current and/or is hotter. In the right half of FIG. 3, the local-sharing signal 310 is higher and thus overrides or dominates, meaning the example power module 202 provides higher load current and/or is hotter. The separate signals are not both present on the local-sharing terminals; rather, in this example the local current-sharing signal is the higher voltage. However, both signals are plotted to explain the overriding or dominating aspects of the example voltage signals. In the left half of FIG. 3, the local-sharing signal from the example power module 200 overrides or dominates, while in the right half of FIG. 3 the local sharing signal from the example power module 202 overrides or dominates.

The switch-node voltage 304 is representative of the voltage at the switch node defined by the switch-node terminal 214 (FIG. 2). Thus, when the switch-node voltage 304 is high, the associated inductor 219 is in a charge mode. When the switch node voltage is low, the associated inductor 219 is in a discharge mode. As shown in the left half of FIG. 3, during the periods of time in which the example power module 200 provides higher load current and/or is hotter, each charge mode begins contemporaneously with the assertion of the drive signal 300 (e.g., at times t1 and t3), and each charge mode ends contemporaneously with de-assertion of the drive signal 300 (e.g., at times t2 and t4).

The switch-node voltage 306 is representative of the voltage at the switch node defined by the switch-node terminal 228 (FIG. 2). Thus, when the switch-node voltage 306 is high, the associated inductor 232 is in a charge mode. When the switch node voltage is low, the associated inductor 232 is in a discharge mode. As shown in the right half of the figure, during the periods of time in which the example power module 202 provides higher load current hotter, each charge mode begins contemporaneously with the assertion of the drive signal 300 (e.g., at times t5 and t7), and each charge mode ends contemporaneously with de-assertion of the drive signal 300 (e.g., at times t6 and t8).

Still referring the switch-node voltage 306 associated with the power module 202, as shown in the left half of FIG. 3, during periods of time in which the example power module 202 is providing lower load current and/or is cooler, the example power module 202 is designed and constructed to extend each charge mode. For example, the example power module 202 may extend the charge mode as shown between times t2 and t2′, in spite of the fact the drive signal goes de-asserted at time t2. Extending the charge mode creates a higher peak current during the charge mode, stores more energy during the charge mode, and provides more current in the subsequent discharge mode. Thus, the example power module 202 carries more current than would be carried if each charge mode ended contemporaneously with the drive signal. Temperature follows current, and thus the example power module 202 will likewise increase in temperature.

As shown in the right half of FIG. 3, during periods of time in which the example power module 200 is providing lower load current and/or is cooler, the example power module 200 is designed and constructed to extend each charge mode. For example, the example power module 200 may extend the charge mode as shown between times t6 and t6′, in spite of the fact the drive signal goes de-asserted at time t6. Extending the charge mode creates a higher peak current during the charge mode, stores more energy during the charge mode, and provides more current in the subsequent discharge mode. Thus, the example power module 200 carries more current than would be carried if each charge modes ended contemporaneously with the drive signal. Temperature follows current, and thus the example power module 200 will likewise increase in temperature.

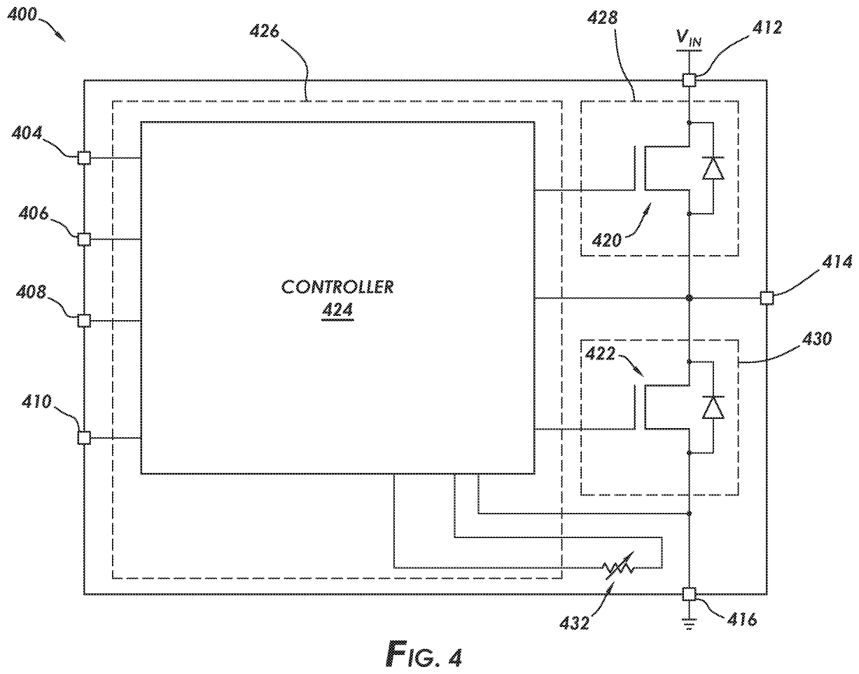

FIG. 4 shows a partial electrical schematic, partial block diagram, of an example power module 400, which could be any of the aforementioned power modules. In particular, FIG. 4 shows a drive-in terminal 404, a current-monitor terminal 406, a temperature-monitor terminal 408, a local-sharing terminal 410, an input-voltage terminal 412, a switch-node terminal 414, and a reference terminal 416. Again, other terminals may be present, but such additional terminals are not shown or described so as not to unduly complicate the discussion. Internally, the example power module 400 implements a high-side electrically-controlled switch illustratively shown as a FET (and hereafter high-side FET 420). The example high-side FET 420 defines a drain coupled to the input-voltage terminal 412, a source coupled to the switch-node terminal 414, and a gate. The example power module 400 further implements a low-side electrically-controlled switch illustratively shown as a FET (and hereafter low-side FET 422). The example low-side FET 422 defines a drain coupled to the switch-node terminal 414, a source coupled to the reference terminal 416, and a gate. The example power module 400 further implements a controller 424. The controller 424 is coupled to the drive-in terminal 404, the current-monitor terminal 406, the temperature-monitor terminal 408, the local-sharing terminal 410, the gate of the high-side FET 420, the switch-node terminal 414, the gate of the low-side FET 422, and the reference terminal 416. To aid in the further discussion, also shown in FIG. 4 are the input voltage V_{IN} and the reference voltage.

The electrical devices of the power module 400 may be monolithically created on one more substrates and encapsulated within packaging to form a packaged-semiconductor product or packaged-semiconductor device. For example, the controller 424 may be constructed on a substrate 426, the high-side FET 420 may be constructed on a substrate 428 distinct from the substrate 426, and the low-side FET 422 may be constructed on a substrate 430 distinct from the other substrates. All three substrates may be electrically coupled to each other and co-packaged (e.g., multi-chip module). In other cases, the controller 424 and low-side FET 422 may be constructed on the same substrate and packaged with a distinct substrate 428 for the high-side FET 420. The various terminals may be electrical connections or pins accessible on the outside surface of the packaging.

The example controller 424 may be, alone or in combinations, individual circuit components, an application specific integrated circuit (ASIC), a microcontroller with controlling software, a reduced-instruction-set computing (RISC) with controlling software, a digital signal processor (DSP), a processor with controlling software, a programmable logic device (PLD), a field programmable gate array (FPGA), or a programmable system-on-a-chip (PSOC), configured to read inputs and drive outputs responsive to the inputs.

Still referring to FIG. 4, example power module 400 further includes a temperature-monitoring device in the example form of a resistive thermal device (hereafter RTD 432). The example RTD 432 is designed, constructed, and/or placed within the packaging such that the RTD 432 is thermally coupled to the high-side FET 420 and/or the low-side FET 422. While the example RTD 432 is shown in the unincorporated region of the power module 400, the RTD 432 may be physically coupled at any suitable location within the power module 400 such that the temperature of the power module 400 may be determined. Use of an RTD 432 as the temperature-monitoring device is only an example, and any currently available or after-developed temperature measurement device or technique may be used to determine the temperature of the power module, such as a thermocouple. The example RTD 432 is electrically coupled to the controller 424. Thus, the controller 424 may read a temperature output of the example RTD 432.

In the example power module 400, the controller 424 is designed and constructed to, responsive to assertion of the drive-in terminal 404 (and putting aside for a moment extending the charge mode), make the low-side FET 422 non-conductive and make the high-side FET 420 conductive. More particularly still, when the drive-in terminal 404 is asserted, the controller 424 makes the low-side FET 422 non-conductive, and after a blanking time the controller 424 makes the high-side FET 420 conductive. The blanking time (e.g., between 100 and 200 nano-seconds (ns)) ensures the input voltage V_{IN} is not shorted to the reference voltage through the FETs. Stated otherwise, the blanking time ensures there is no cross-conduction of the input voltage V_{IN} through the FETs to the ground or common.

The controller 424 is further designed and constructed, during the charge and discharge modes, to drive a signal indicative of the current provided to the switch-node terminal 414, and thus the downstream inductor and load (not shown). In one example power module 400, the signal indicative of current is created by measuring the voltage drop across the low-side FET 422 during each discharge mode. That is, even in a fully conductive state, the low-side FET 422 has an inherent resistance (Rds(on)). Thus, the current through the low-side FET 422 produces a voltage drop with a magnitude over time directly proportional to the magnitude over time of the current provided to the switch-node terminal 414. In this example, during each charge mode the controller 424 is designed and constructed to drive, to the current-monitor terminal 406, an emulated signal generated based on the current through the inductor in the prior discharge mode. In yet still other cases, the signal indicative of current may be created by the controller 424 measuring the voltage drop across the high-side FET 420 during each charge mode, and creating an emulated signal during each discharge mode. In yet still further cases, the signal indicative of current may be created by the controller 424 measuring voltage drop across the high-side FET 420 during charge modes and measuring voltage drop across the low-side FET 422 during discharge modes.

Further in accordance various examples, the controller 424 of the power module 400 may be designed and constructed to drive a signal indicative of temperature to the temperature-monitoring terminal 408. In particular, the controller 424, during charge modes and/or discharge modes, reads a temperature signal produced by the example RTD 432, and drives the signal indicative of temperature to the temperature-monitoring terminal 408. As discussed above, the voltage regulator 102 (FIG. 1) uses the signal indicative of current and the (higher of) the signal indicative of temperature to control the phase within which the example power module 400 operates.

The example power module 400 is further designed and constructed to drive the local-sharing signal to the local-sharing terminal 410. In one example, the local-sharing signal may be defined by the following equation:

$$LCS\_ic = Kt \cdot Tmon\_ic + Kc \cdot Imon \qquad ( 1 )$$

where LCS_ic is the local-sharing signal, Kt is a proportionality constant for the temperature contribution, Tmon_ic is the signal indicative of temperature, Kc is a proportionality constant for the current contribution, and Imon is the signal indicative of current. The proportionality constants Kt and Kc, which may be set at the time of manufacture, define the relative contributions of the temperature and current, respectively, to the local-sharing signal. For example, if Kt is zero, then the local-sharing signal balances only current as between the power modules. If Kc is zero, then the local-sharing signal balances only temperature as between the power modules. If Kc and Kt are both non-zero, then local-sharing signal at least partially balances current, and at least partially balance temperature, as between the power modules belonging to the same phase.

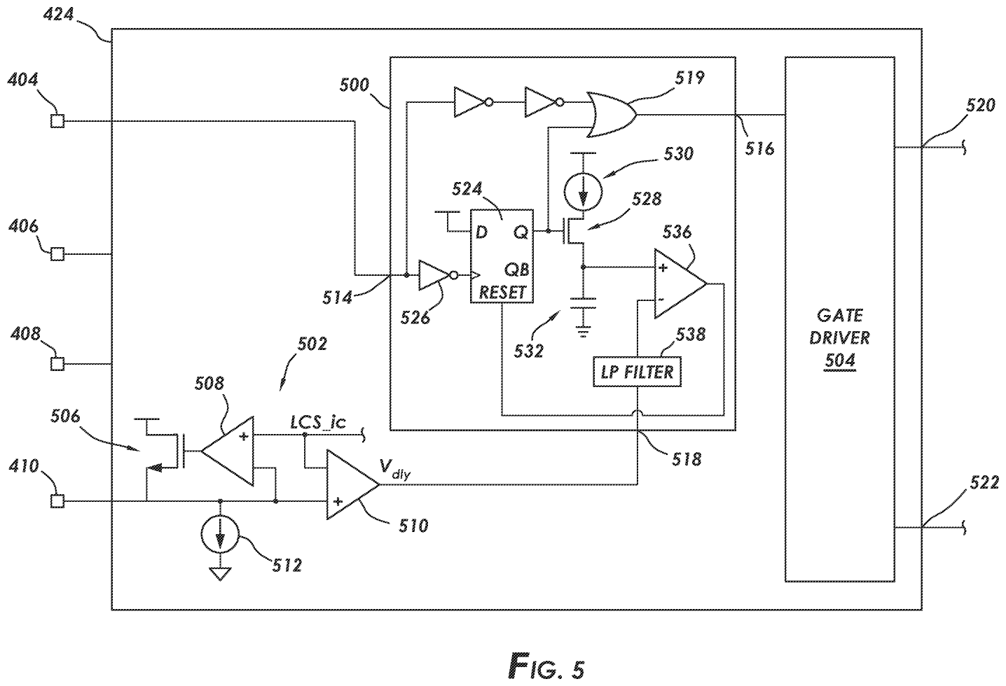

FIG. 5 shows a partial electrical schematic, partial block diagram, of the controller 424. In particular, FIG. 5 shows an example falling-edge delay circuit 500, an example local-sharing circuit 502, and a gate driver 504. Other components of the controller 424 will be present, such as circuits to drive the current-monitor signal and the temperature-monitor signal to the current-monitor terminal 406 and the temperature-monitor terminal 408, respectively, but are not shown so as not to unduly complicate the figure and the discussion.

Referring initially to the local-sharing circuit 502, the example local-sharing circuit 502 includes a drive transistor illustratively shown as a FET 506, an operational amplifier 508, a comparator 510, and a current source 512. The FET 506 has a drain coupled to a voltage rail, a source coupled to the local-sharing terminal 410, and a gate. The operational amplifier 508 has a drive output coupled to the gate of the FET 506, a non-inverting input coupled to the LCS_ic signal, and an inverting input coupled the source of the FET 506. Thus, the FET 506 and operational amplifier 508 are set up as source-follower amplifier. In order to provide a bias current for the FET 506, the current source 512 draws a constant current. In operation, the LCS_ic signal is applied to the non-inverting input of the operational amplifier 508. The drive output and FET 506 thus attempt to make the voltage at the source closely match the voltage at the non-inverting input. If the power module 400 within which the example controller 424 resides is providing more current and/or is hotter (depending on the constants Kc and Kt discussed above) than any of the parallel power modules, in the example case the voltage on the local-sharing terminal 410 will override or be dominated by the voltage supplied through the FET 506. Oppositely, if the power module 400 within which the example controller 424 resides is providing less current and/or is cooler than any of the parallel power modules, in the example case the voltage on the local-sharing terminal 410 will be overridden or dominated by the voltage supplied from the parallel power module. That is, the voltage at the source of the FET 506 will be higher than the voltage on the non-inverting input of the operational amplifier 508, and thus the current through the FET will likely be reduced to zero by the operational amplifier 508.

The comparator 510 has a non-inverting input coupled to the local-sharing terminal 410, an inverting input coupled to the LCS_ic signal, and a comparator output. Additional external resistors may be present, such as to control the gain of the comparator 510, but those additional external resistors are not shown so as not to unduly complicate the discussion. Thus, the comparator 510 generates a signal indicative of the difference between the LCS_ic signal and the local-sharing signal on the local-sharing terminal 410. When the power module 400 within which the example controller 424 resides is providing more current and/or is hotter, the LCS_ic signal is about the same as local-sharing signal, and thus the signal on the compare output will be about zero. Oppositely, when the power module 400 within which the example controller 424 resides is providing less current and/or is cooler, the LCS_ic signal is lower than local-sharing signal, and thus the signal on the compare output will be non-zero and have a magnitude proportional to the difference between the LCS_ic signal and the local-sharing signal. In accordance with various example, the signal on the compare output is referred to as the Vdly signal, and the falling-edge delay circuit 500 extends charge modes by an amount of time proportional to the magnitude of the Vdly signal.

Still referring to FIG. 5, the example falling-edge delay circuit 500 defines a drive input 514, a drive output 516, and a Vdly input 518. Internally, the example falling-edge delay circuit 500 defines a logic OR gate 519 having a first input coupled to the drive input 514, a second input, an output defining the drive output 516. The two inverting buffers between the drive input 514 and the logic OR gate 519 provide delay for timing purposes associated with extending charge modes. When the drive signal applied to the drive-in terminal 404 is asserted, the drive output 516 is asserted. The example gate driver 504 defines a drive-input coupled to the drive output 516, a high-side gate output 520 coupled to the gate of the high-side FET 420 (FIG. 4), and a low-side gate output 522 coupled to the gate of the low-side FET 422 (FIG. 4). When the drive output 516 is asserted, the gate driver 504 de-asserts the low-side gate output 522, and after a blanking time asserts the high-side gate output 520. Likewise, when the drive output 516 is de-asserted, the gate driver 504 de-asserts the high-side gate output 520, and after a blanking time asserts the low-side gate output 522. Moreover, the gate driver 504 provides current and/or voltages used adequately to control the gates of the high-side FET 420 and the low-side FET 422.

The example falling-edge delay circuit 500 further incudes a latch 524 illustratively shown as a D flip flop defining D input, a latch output Q, a reset input, and a clock input. The drive input 514 is coupled to the clock input by way of an inverter 526. The latch output Q is coupled to the gate of a FET 528 having a drain coupled to a current source 530 and a source coupled to a capacitor 532. The latch output Q is also coupled to the second input of the logic OR gate 519. When the drive signal on the drive input 514 is de-asserted, the latch 524 is clocked, latching the state of the D input on the latch output Q. In this example, the D input is tied to an asserted state (here, asserted with a high voltage), and thus the de-assertion of the drive signal latches an asserted state on the latch output Q. When the latch output Q is asserted, the FET 528 is conductive, and thus current flows to the capacitor 532, creating a ramp signal in the form of a voltage on the capacitor 532.

The example falling-edge delay circuit 500 further incudes a comparator 536 defining a non-inverting input coupled to the capacitor 532, an inverting input coupled the Vdly input 518 by way of an example low-pass filter 538, and a compare output coupled to the reset input of the latch 524. Thus, when the ramp signal on the capacitor 532 transitions through the Vdly signal, the compare output of the comparator 536 is asserted, the latch output Q is de-asserted, and the FET 528 becomes non-conductive.

Consider periods of time in which the power module 400 within which the example controller 424 resides is providing more current and/or is hotter. Thus, the LCS_ic signal is about the same as local-sharing signal, and the Vdly signal is about zero. When the drive signal applied to the drive-in terminal 404 and the drive input 514 is asserted, the logic OR gate 519 asserts the drive output 516. When the drive signal applied to the drive-in terminal 404 and the drive input 514 is de-asserted, the latch 524 asserts the latch output Q, and the ramp signal on the capacitor 532 starts to rise. However, under the assumptions the Vdly signal is about zero, so the comparator 536 asserts the reset input of the latch 524 soon thereafter. It follows that both inputs of the logic OR gate 519 are de-asserted, which de-asserts the drive output 516.

Now consider periods of time in which the power module 400 within which the example controller 424 resides is providing less current and/or is cooler. Thus, the LCS_ic signal has a magnitude below the local-sharing signal, and the Vdly signal takes on a non-zero value proportional to the difference between the magnitudes of the LCS_ic local-sharing signal. When the drive signal applied to the drive-in terminal 404 and the drive input 514 is asserted, the logic OR gate 519 asserts the drive output 516. When the drive signal applied to the drive-in terminal 404 and the drive input 514 is de-asserted, the latch 524 asserts the latch output Q, and the ramp signal on the capacitor 532 starts to rise. However, under the assumptions the Vdly signal is non-zero, so the comparator 536 asserts the reset input of the latch 524 after a finite amount of time it takes for the ramp signal to cross the Vdly signal. It follows that latch output Q holds the drive output 516 asserted, through the logic OR gate 519, until the comparator 536 asserts the reset input of the latch 524. Thus, the example controller extends the charge mode based on signal at the local-sharing terminal, and more particularly extends the charge mode proportional to the difference between the LCS_ic (i.e., the local current-sharing signal) and the signal on the local-sharing terminal 410, in this example carrying the dominate non-local current sharing signal.

The example local-sharing circuit 502 and falling-edge delay circuit 500 are just that, examples. One having ordinary skill in the art, with the benefit of this disclosure, could design multiple functionally equivalent analog or digital circuits to implement extending charge modes in conformance with this description and claims.

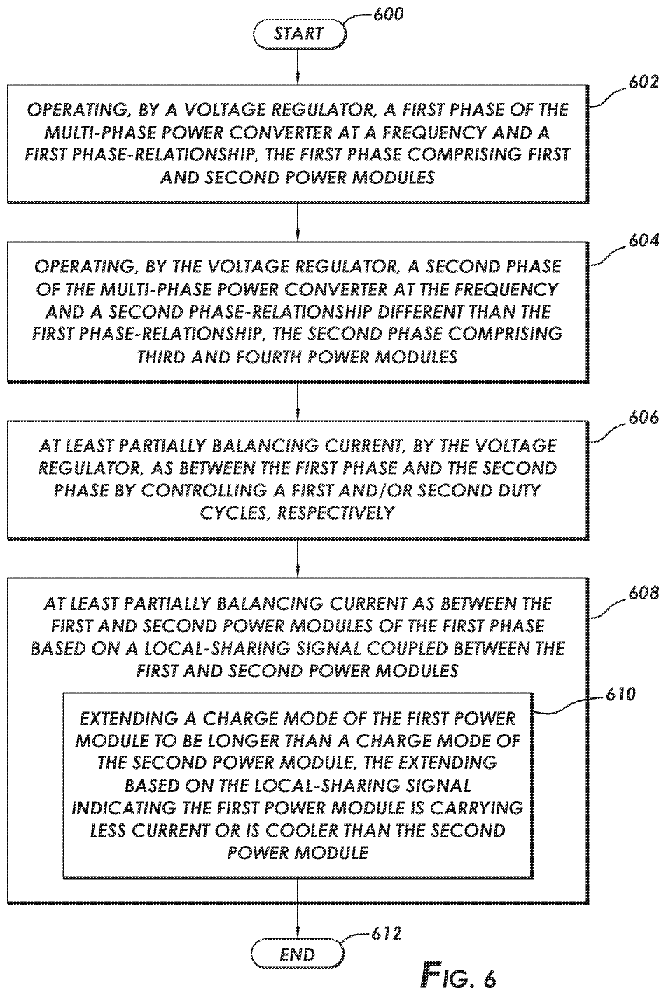

FIG. 6 shows a method in accordance with at least some embodiments. in particular, the method starts (block 600) and comprises: operating, by a voltage regulator, a first phase of the multi-phase power converter at a frequency and a first phase-relationship, the first phase comprising first and second power modules (block 602); operating, by the voltage regulator, a second phase of the multi-phase power converter at the frequency and a second phase-relationship different than the first phase-relationship, the second phase comprising third and fourth power modules (block 604); at least partially balancing current, by the voltage regulator, as between the first phase and the second phase by controlling the first and/or second duty cycles, respectively (block 606); and at least partially balancing current as between the first and second power modules of the first phase based on a local-sharing signal coupled between the first and second power modules (block 608). In some example cases, at least partially balancing current as between the first and second power modules further comprises, extending a charge mode of the first power module to be longer than a charge mode of the second power module, the extending based on the local-sharing signal indicating the first power module is carrying less current or is cooler than the second power module (block 610). Thereafter, the method ends (block 612), likely to be repeated in the next switching cycle.

Many of the electrical connections in the drawings are shown as direct couplings having no intervening devices, but not expressly stated as such in the description above. Nevertheless, this paragraph shall serve as antecedent basis in the claims for referencing any electrical connection as “directly coupled” for electrical connections shown in the drawing with no intervening device(s).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method of operating a multi-phase power converter, the method comprising:
operating, by a voltage regulator, a first phase of the multi-phase power converter at a frequency and a first phase-relationship, the first phase comprising first and second power modules;
operating, by the voltage regulator, a second phase of the multi-phase power converter at the frequency and a second phase-relationship different than the first phase-relationship, the second phase comprising third and fourth power modules;
at least partially balancing current, by the voltage regulator, as between the first phase and the second phase by controlling a first or second duty cycles, respectively; and
at least partially balancing current as between the first and second power modules of the first phase based on a local-sharing signal coupled between the first and second power modules.

2. The method of claim 1 wherein at least partially balancing current as between the first and second power modules further comprises, extending a charge mode of the first power module to be longer than a charge mode of the second power module, the extending based on the local-sharing signal indicating the first power module is carrying less current or is cooler than the second power module.

3. The method of claim 1 wherein at least partially balancing current as between the first and second power modules further comprises, extending a charge mode of the first power module to be longer than a charge mode of the second power module, the extending based on the local-sharing signal indicating the first power module is cooler than the second power module.

4. The method of claim 1 wherein at least partially balancing current as between the first and second power modules further comprises, extending a charge mode of the first power module to be longer than a charge mode of the second power module, the extending based on the local-sharing signal indicating the first power module is carrying less current and is cooler than the second power module.

5. The method of claim 1 wherein at least partially balancing current as between the first and second power modules further comprises:
coupling, by the first power module, an input voltage to a first switch node responsive to assertion of a first drive signal from the voltage regulator, the coupling defines a first charge mode;
coupling, by the second power module, the input voltage to a second switch node responsive to assertion of the first drive signal;
responsive to de-assertion of the first drive signal, de-coupling the second switch node from the input voltage and coupling the second switch node to ground by the second power module;
responsive to de-assertion of the first drive signal, extending the first charge mode by the first power module, the extending based on the local-sharing signal indicating the first power module is carrying less current or is cooler than the second power module; and then
de-coupling the first switch node from the input voltage and coupling the first switch node to ground by the first power module.

6. A power module, comprising:
a drive-in terminal, a current-monitor terminal, a temperature-monitor terminal, a local-sharing terminal, and a switch-node terminal;
a high-side FET defining a drain, a source coupled to the switch-node terminal, and a gate;
a low-side FET defining a drain coupled to the switch-node terminal, a source, and a gate;
a means for measuring temperature thermally coupled to the high-side FET and the low-side FET, the means for measuring temperature defines a temperature output;
a controller coupled to the gate of the high-side FET, the gate of the low-side FET, the drive-in terminal, the current-monitor terminal, the temperature-monitor terminal, the local-sharing terminal, and the temperature output, the controller configured to:
responsive to assertion of the drive-in terminal, make the low-side FET non-conductive and the high-side FET conductive to define a charge mode;
drive a signal indicative of current to the current-monitor terminal;
drive a signal indicative of temperature to the temperature-monitor terminal;
responsive to de-assertion of the drive-in terminal, extend the charge mode based on a signal at the local-sharing terminal; and then
make the high-side FET non-conductive and the low-side FET conductive to define a discharge mode.

7. The power module of claim 6 wherein when the controller extends the charge mode, the controller is configured to extend the charge mode if the signal on the local-sharing terminal indicates the power module carries less current than a parallel power module coupled to the local-sharing terminal.

8. The power module of claim 6 wherein when the controller extends the charge mode, the controller is configured to extend the charge mode if the signal on the local-sharing terminal indicates the power module has a lower temperature than a parallel power module coupled to the local-sharing terminal.

9. The power module of claim 6 wherein when the controller extends the charge mode, the controller is configured to extend the charge mode if the signal on the local-sharing terminal indicates the power module both: carries less current than a parallel power module coupled to the local-sharing terminal; and has a lower temperature than the parallel power module coupled to the local-sharing terminal.

10. The power module of claim 6 wherein the controller is further configured to refrain from extending a second charge mode if the signal on the local-sharing terminal indicates the power module carries the same or more current than a parallel power module coupled to the local-sharing terminal.

11. The power module of claim 6 wherein the controller is further configured to refrain from extending a second charge mode if the signal on the local-sharing terminal indicates the power module has a same or a higher temperature than a parallel power module coupled to the local-sharing terminal.

12. The power module of claim 6 wherein the controller is further configured to refrain from extending a second charge mode if the signal on the local-sharing terminal indicates the power module either: carries the same or more current than a parallel power module coupled to the local-sharing terminal; or has the same or higher temperature than the parallel power module coupled to the local-sharing terminal.

13. A multi-phase power converter, comprising:
a voltage regulator defining first and second phase-drive terminals, first and second I_{MON}-input terminals, first and second T_{MON}-input terminals, and a voltage-feedback terminal, the voltage regulator configured to drive a first-phase drive signal to the first phase-drive terminal at a first phase and to drive a second-phase drive signal to the second phase-drive terminal at a second phase different than the first phase;
a first phase defining a first drive input coupled to the first phase-drive terminal, a first current-monitor output coupled to the first I_{MON}-input terminal, and a first temperature monitor output coupled to the first T_{MON}-input terminal;
a second phase comprising:
a first power module defining a first drive-in terminal, a first current-monitor terminal, a first temperature-monitor terminal, a first local-sharing terminal, and a first switch-node terminal coupled to a first inductor;
a second power module defining a second drive-in terminal, a second current-monitor terminal, a second temperature-monitor terminal, a second local-sharing terminal, and a second switch-node terminal coupled to a second inductor;
the first and second drive-in terminals coupled together and defining a second drive input coupled to the second phase-drive terminal;
the first and second current-monitor terminals coupled together and defining a second current-monitor output coupled to the second T_{MON}-input terminal;
the first and second temperature-monitor terminals coupled together and defining a second temperature monitor output coupled to the second T_{MON}-input terminal;
the first and second local-sharing terminals coupled together;
the voltage regulator configured to at least partially balance current as between the first and second phases based on the first and second I_{MON}-input terminals and/or the first and second T_{MON}-input terminals; and
the first and second power modules configured to at least partially balance current as between the first and second power modules based on the first and second local-sharing terminals.

14. The multi-phase power converter of claim 13:
wherein the first power module is configured to: couple an input voltage to the first switch-node terminal responsive to assertion of the first drive-in terminal to define a first charge mode; drive a signal indicative of current to the first current-monitor terminal; drive a signal indicative of temperature to the first temperature-monitor terminal; responsive to de-assertion of the first drive-in terminal, extend the first charge mode based on a signal at the first local-sharing terminal; and then couple a ground reference to the first switch-node terminal to define a first discharge mode; and
wherein the second power module is configured to: couple the input voltage to the second switch-node terminal responsive to assertion of the first drive-in terminal; drive a signal indicative of current to the second current-monitor terminal; drive a signal indicative of temperature to the second temperature-monitor terminal; and responsive to de-assertion of the first drive-in terminal during the first discharge mode, couple a ground reference to the second switch-node terminal.

15. The multi-phase power converter of claim 14 wherein when the first power module extends the first charge mode, the first power module is configured to extend the first charge mode if the signal on the first local-sharing terminal indicates the first power module carries less current than the second power module.

16. The multi-phase power converter of claim 14 wherein when the first power module extends the first charge mode, the first power module is configured to extend the first charge mode if the signal on the first local-sharing terminal indicates the first power module has a lower temperature than the second power module.

17. The multi-phase power converter of claim 14 wherein when the first power module extends the first charge mode, the first power module is configured to extend the first charge mode if the signal on the first local-sharing terminal indicates the first power module both: carries less current than the second power module; and has a lower temperature than the second power module.

18. The multi-phase power converter of claim 14 wherein the second power module is further configured to extend a second charge mode if the signal on the second local-sharing terminal indicates the second power module carries less current than the first power module.

19. The multi-phase power converter of claim 14 wherein the second power module is further configured to extend a second charge mode if the signal on the second local-sharing terminal indicates the second power module has a lower temperature than the first power module.

20. The multi-phase power converter of claim 14 wherein the second power module is further configured to extend a second charge mode if the signal on the second local-sharing terminal indicates the second power module both: carries less current than the first power module; and has a lower temperature than the first power module.
